(19) United States
(12) Patent Application Publication
(10) Pub. No.: US 2023/0119514 A1
(43) Pub. Date: Apr. 20, 2023

(54) SENSOR UNIT, MEASURING METHOD AND PRODUCTION METHOD

(71) Applicant: PRESENS PRECISION SENSING GMBH, Regensburg (DE)

(72) Inventor: Daniel Riechers, Regensburg (DE)

(21) Appl. No.: 18/067,211

(22) Filed: Dec. 16, 2022

Related U.S. Application Data
(63) Continuation of application No. PCT/IB2021/054959, filed on Jun. 7, 2021.

(30) Foreign Application Priority Data
Jun. 16, 2020 (DE) 10 2020 115 791.6

(51) Int. Cl. G01N 21/77; G01N 21/63; G01N 31/22

(52) U.S. Cl. CPC G01N 21/77; G01N 21/63; G01N 31/22; G01N 2021/775

(57) ABSTRACT

In a sensor unit, a sensor element having an optical behavior that depends on at least one analyte is in diffusive contact with an auxiliary medium, which is present in a reservoir in the sensor unit, via a membrane. The reservoir and the membrane, on the one hand, and sensor element, on the other hand, can be removed from one another in order to place the sensor unit in a measurement state. The auxiliary medium can serve to wet the sensor element during storage of the sensor unit or also for calibrating the sensor element.

### CROSS-REFERENCE TO RELATED APPLICATIONS

This application is a Continuation Application of International Application PCT/IB2021/054959, filed on Jun. 07, 2021, which in turn claims priority to German Application DE 10 2020 115 791.6, filed Jun. 16, 2020, both of which are incorporated herein by reference in their entirety.

### BACKGROUND

The present disclosure relates to a sensor unit for measuring an analyte in a sample, a corresponding measurement method using the sensor unit and a method for manufacturing the sensor unit.

The use of sensors for detecting an analyte in a sample is known, see for example the German Patent Applications DE 10 2010 061 182 A1, DE 10 2011 055 272 A1, DE 10 2014 107 837 A1 or the German Patent DE 10 2013 108 659 B3, as well as the prior art documents cited therein.

Such sensors contain a sensor substance which is sensitive to an analyte of the sample, i.e., a substance to be detected in the sample. For example, the sensor substance can have an optical behavior which is influenced by the analyte in a direct or indirect manner. From the evaluation of the optical behavior, quantitative conclusions on the analyte can be inferred, that is to say for example concentration or partial pressure of the analyte can be determined, depending on the type of analyte. Sensors of this type, their structure, sensor substances suitable for respective analytes and use conditions, and measurement methods for evaluating the optical behavior of the sensor or the sensor substance are known to the person skilled in the art, for example from the above-mentioned prior art.

In several of the sensors, prior to being used for a measurement, it is necessary to wet the sensor with a suitable solution in order to establish readiness for use. This preparation phase before the measurement is for example a disadvantage, if measurement results are required within a short period of time, and generally is awkward for a user.

European Patent Application EP 0 354 895 A2 relates to a disposable measuring element in which a sensor is arranged in a measuring region of a measuring channel closed on both sides prior to a measurement. The measuring channel is filled with a calibration and storage medium. For measurement, the calibration and storage medium is displaced by a sample flowing into the measurement channel. The sensor may be an optical sensor. The closure of the measuring channel can be realized by a pierceable membrane. With a similar configuration, European Patent Application EP 0 460 343 A2 proposes to first displace the storage medium by a separating medium, which may be a calibration medium, and subsequently to displace the separating medium by the sample.

German utility model DE 20 2010 006 207 U1 relates to various arrangements with which it is possible to separate a region containing a sensor at least temporarily from a sample region in a measuring arrangement. The purpose is to protect the sensor during sterilization. In certain embodiments, the sensor is surrounded by an aqueous reducing agent.

U.S. Pat. Application US 2012/0267518 A1 discloses a sensor which is arranged in a storage area for protection during sterilization and can be displaced from the storage area into a sample area.

Protection during sterilization is an important aspect in the use of sensors but cannot solve the problem of waiting time until readiness for use. The solution proposed in the prior art for this purpose of storing the sensor surrounded by a storage medium in the measurement region of a measurement channel requires the connection of containers or tubing for the sample to the measurement channel. This makes handling complex.

### SUMMARY

The present disclosure provides a sensor unit in which the effort for the wetting of the sensor in advance of a measurement is eliminated.

This is achieved by a sensor unit which comprises a sensor element which has an optical behavior which depends on at least one analyte of a sample, and a reservoir with an auxiliary medium. A membrane is provided which, in a preparation state of the sensor unit, enables a diffusive contact between the auxiliary medium and the sensor element. By removing the sensor element, on the one hand, and the membrane and the reservoir, on the other hand, from one another, the sensor unit can be placed in a measurement state.

The present disclosure further provides a sample vessel for a sensor unit so that the effort for the wetting of the sensor in advance of a measurement is eliminated. This is achieved by a sample vessel which has a sensor unit positioned in the sample vessel. A sensor element of the sensor unit has an optical behavior which depends on at least one analyte of a sample. A reservoir of the sensor unit is provided with an auxiliary medium. A membrane of the sensor unit which, in a preparation state of the sensor unit, enables a diffusive contact between auxiliary medium and sensor element, wherein the sensor unit is placed in a measurement state by removal from one another of the sensor element on the one hand and of the membrane and of the reservoir on the other hand. The present disclosure also provides a method of measuring an analyte in a sample wherein the effort for wetting a sensor of a sensor unit in advance of a measurement is eliminated and contamination of the sample is avoided.

This is achieved by a method of measuring an analyte in a sample comprising at least the following steps:
providing a sample vessel with a sensor unit, wherein the sensor unit comprises:
   a sensor element comprising an optical behavior, wherein the optical behavior depends on at least one analyte of a sample;
   a reservoir with an auxiliary medium; and
   a membrane, wherein, in a preparation state of the sensor unit, the membrane enables a diffusive contact between the auxiliary medium and the sensor element, wherein the sensor unit is placed in a measurement state by removal from one another of the sensor element on the one hand and of the membrane and of the reservoir on the other hand;
sterilizing the sample vessel;
removing the sensor element, on the one hand, and the reservoir and the membrane, on the other hand, from one another in order to make the sensor element accessible from the sample vessel;
filling the sample vessel with the sample; and
performing a measurement of the analyte using the sensor element of the sensor unit.

The present disclosure further provides a method for manufacturing a sensor unit so that the effort for the wetting of the sensor in advance of a measurement is eliminated.

This is achieved by a method for manufacturing a sensor unit, comprising at least the steps:
creating a cavity in a precut foil;
attaching a sensor element to a transparent support, wherein the sensor element comprises an analyte dependent optical behavior;
filling the cavity with an auxiliary medium;
laying a membrane on the filled cavity and fastening the membrane to the foil, wherein the membrane is diffusive for the auxiliary medium;
placing the support with the sensor element on the membrane, so that the sensor element is configured toward the membrane in order to come into contact with the auxiliary medium diffused through the membrane; and
fixing the support on the foil such that the foil together with the membrane and the cavity with the auxiliary medium can be removed from the support with the sensor element.

In the measurement state of the sensor unit, the sensor unit is ready for measuring the analyte. In the preparation state of the sensor unit, the sensor unit can be stored; it is sometimes also possible to carry out procedures in advance of a measurement, for example sterilization of the sensor unit or of a sample container in which the sensor unit is located. The optical behavior of the sensor element, which depends on the at least one analyte, results, for example, from the fact that a sensor substance of the type mentioned at the beginning is contained in the sensor element. Without restricting the present disclosure, the sensor substance may be embedded in a carrier or applied to the surface of a carrier. The carrier may, for example, comprise a polymer. The optical behavior of the sensor substance may be luminescence, for example. For example, the sensor substance may be a luminescent dye and, for example, an intensity of the luminescent light, a decay time of the intensity of the luminescent light, a polarization of the luminescent light, a decay time of the polarization of the luminescent light or another parameter of the luminescent light may directly or indirectly depend on the analyte. Intensity, decay times, polarization or other parameters of the luminescent light can be measured by known methods. Another example of the optical behavior of a sensor substance or of the sensor element is the color. That is, the color of the sensor element can directly or indirectly depend on the analyte. The color can be measured by known methods. Non-limiting examples of analytes include oxygen, carbon dioxide, pH.

In the preparation state of the sensor unit according to embodiments of the present disclosure, a diffusive contact between the sensor element and the auxiliary medium in the reservoir is provided via the membrane. In this way, the sensor element is already wetted by the auxiliary medium in the preparation state, for instance during the storage of the sensor unit. A waiting time or additional steps directly before the use of the sensor unit or before a measurement are therefore omitted.

Should growth of microorganisms occur in the reservoir, such growth would have scarcely any effects on a measurement with the sensor unit according to the present disclosure. This is because the reservoir (including the possible growth of microorganisms) is removed from the sensor element before the measurement.

In one embodiment, the reservoir and the membrane are detachably connected to the sensor unit. The sensor element on the one hand and the membrane and the reservoir on the other hand can easily be removed from one another by detaching the reservoir and membrane from the sensor unit, for instance by pulling them off.

In a specific embodiment, a cap is provided to cover the reservoir and the sensor element. This cap protects the sensor unit during storage and also during sterilization of a sample vessel containing the sensor unit. In an even more specific embodiment, the sensor element is arranged on a support. The cap is releasably connected to the support, and the membrane is fastened in the cap and delimits the reservoir together with the cap. In this embodiment, the reservoir and membrane together with the cap can simply be pulled off the support and thus removed from the sensor element.

In another embodiment, the sensor unit has a sensor part and a reservoir part different therefrom. The sensor element is attached to the sensor part. In the reservoir part, the reservoir is formed and the membrane is attached. The reservoir part and sensor part are rotatable and/or displaceable relative to one another. By a corresponding rotation or displacement, the sensor element on the one hand and membrane and reservoir on the other hand can be removed from one another.

In a further embodiment, the sensor part has a channel in which a light guide can be guided. The light guide serves to guide light to the sensor element and/or to guide light away from the sensor element.

In additional embodiments, the reservoir part may have an opening through which the sensor element is accessible from an environment of the sensor unit in the measurement state of the sensor unit. Via this opening, the sensor element can come into contact with a sample in which an analyte is to be measured.

In a general embodiment of the sensor unit according to embodiments of the present disclosure, the auxiliary medium is a storage medium for storing the sensor element in a wetted state in the sensor unit. The storage medium can for example be water or contain a lye, e.g., sodium hydroxide solution. A lye can serve, for example, to neutralize acids which can arise when the sensor unit is irradiated. Irradiation of the sensor unit can be necessary in the course of sterilization, but the acids which are produced in this case can damage the sensor element. Neutralization of these acids therefore ensures the functionality of the sensor element despite irradiation. The storage medium may also contain an antimicrobial preservative, particularly a non-volatile preservative such as benzethonium chloride. Such a preservative suppresses the growth of microorganisms in the reservoir and thus avoids corruption of measurement results due to the presence of these microorganisms, for instance due to their metabolism, even more reliably than solely by the construction of the sensor unit, as explained above.

In embodiments of the present disclosure, the storage medium is used to set a defined state for calibrating the sensor element. By way of non-limiting example, if the sensor unit is designed to measure the partial pressure of CO₂, a phosphate buffer with a few millimoles of bicarbonate and an exactly adjusted pH can be used as the storage medium. Such a buffer is radiation-stable and develops a reproducible CO₂ partial pressure. This can be used for a one-point calibration of the sensor element.

A sample vessel according embodiments of the present disclosure has a sensor unit as described above. The sample vessel is not limited in shape. It may be a single-use or a reusable sample vessel. Non-limiting examples of the sample vessel include cups, bags, bioreactors, and flow-through elements.

The sample vessel may be sterilized. Since the sensor element in the preparation state is protected from irradiation or irradiation products, the sample vessel with the attached sensor unit can be sterilized by irradiation without impairing the sensor element of the sensor unit.

The protection of the sensor element in the sensor unit also makes it possible, during the manufacture of the sample vessel, to give less consideration to materials that can influence the sensor element (such as influence by materials of the sample vessel or by auxiliaries such as adhesives). During the storage of the sample vessel with an installed sensor unit, the sensor element in the sensor unit is protected, for example, against evaporations from the materials and auxiliaries. While measuring, such evaporations are displaced by the sample.

A method according to the present disclosure for measuring an analyte in a sample comprises at least the following steps:

First, a sample vessel with a sensor unit according to the present disclosure as described above is provided. The sample vessel is then sterilized, for example by irradiation. Therein, the sensor unit is still in the preparation state, thus the sensor element is still protected.

Subsequently, the sensor unit is put into the measurement state by removing the sensor element on the one hand and the reservoir and the membrane on the other hand from one another. The sensor element thereby becomes accessible from the sample vessel. Furthermore, the sample vessel is filled with the sample.

When the sample has been filled into the sample vessel and the sensor unit has been placed in the measurement state, the measurement of the analyte is performed using the sensor element of the sensor unit.

### BRIEF DESCRIPTION OF THE DRAWINGS

The present disclosure is explained in more detail below with reference to the attached schematic figures. The figures therefore are not intended to be construed as limitations of the invention to these specific embodiments.

FIG. 1 shows an embodiment of a sensor unit according one embodiment in sectional view.

FIG. 2 shows the embodiment of the sensor unit of FIG. 1 in plan view.

FIG. 3 shows a further embodiment of a sensor unit in sectional view in the preparation state.

FIG. 4 shows the embodiment from FIG. 3 in a sectional view in the measurement state.

FIGS. 5A-C illustrate the preparation for a measurement using a sensor unit illustrated in FIGS. 1 and 2.

### DETAILED DESCRIPTION

The present disclosure will now be described more specifically with reference to the following embodiments. It is to be noted that the following description is presented herein for purpose of illustration and description only. It is not intended to be exhaustive or to be limited to the precise form disclosed.

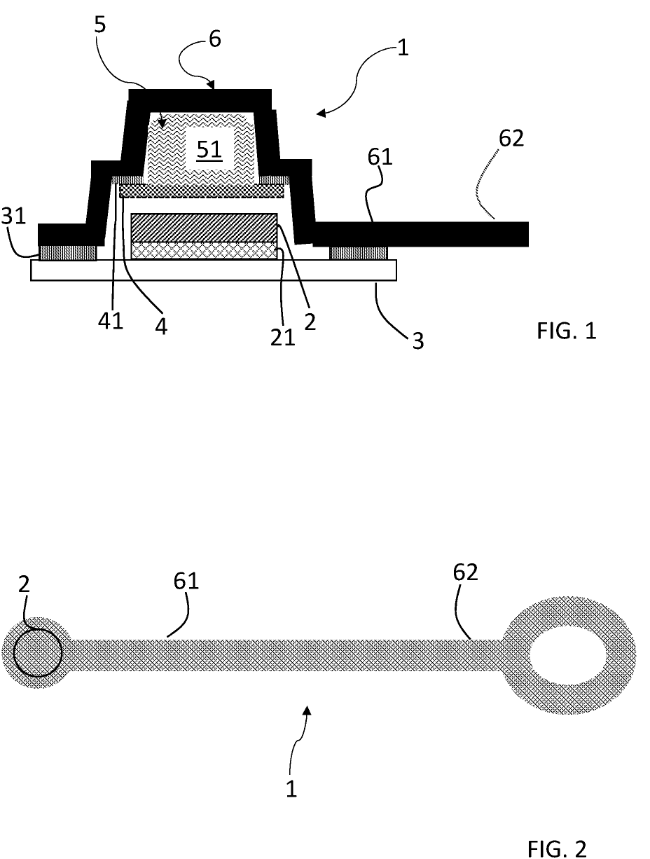

FIG. 1 shows an embodiment of a sensor unit 1 of the present disclosure in sectional view. A sensor element 2 is fastened to a transparent support 3, in the example shown with a double-sided adhesive tape 21. Via a membrane 4, the sensor element 2 is in diffusive contact with an auxiliary medium 51, which is located in a reservoir 5. The reservoir 5 is delimited, apart from the membrane 4, by a cap 6, which is formed as a cavity in a foil 61. The foil 61 extends into a handle 62, which is only partially shown here. The membrane 4 is fixed to the foil 61 by a weld ring 41. Furthermore, the foil 61 is fastened to the support 3 via a weld ring 31. In the illustrated state, the sensor unit 1 is in the preparation state. The sensor element 2 is protected by the cap 6, in particular during irradiation for the purpose of sterilization. The diffusive contact between auxiliary medium 51 and sensor element 2 facilitated by membrane 4 ensures a wetting of sensor element 2 in the preparation state in which sensor unit 1 can be stored.

The foil 61 can be an aluminum foil or a plastic-aluminum composite foil, for example, low-density polyethylene (LDPE). The support 3 may be, for example, a cycloolefin copolymer (COC). The membrane 4 may be, for example, microporous polypropylene (PP).

The transparent support 3 allows light to pass through the support 3 to the sensor element 2 and/or to detect light from the sensor element 2 through the support 3 for the purpose of evaluating the optical behavior of the sensor element 2. This implies that “transparent” here means that the support 3 is transparent for relevant light wavelengths to such an extent that the measurement of the analyte is possible with a desired accuracy. In the same sense, the adhesive tape 21 must then also be transparent.

In the illustration, the membrane 4 is fastened to the foil 61 via weld ring 41. It would also be conceivable, for example, to fasten the membrane 4 with a clamping ring, wherein the clamping ring is then fastened to the foil 61, for example via a weld ring.

FIG. 2 shows a plan view of the sensor unit 1 shown in FIG. 1. Here, the handle 62 is shown completely. The sensor element 2 is indicated by a circle. By the handle 62, cf. FIG. 1, the cap 6 together with the reservoir 5 and the membrane 4 can be pulled off the support 3, wherein the connection provided by the weld ring 31 is released. More precisely, the weld ring 31 detaches from the support 3 and remains on the foil 61, while the connection provided by the weld ring 41 remains. The sensor element 2 is then accessible from outside the sensor unit 1. The sensor unit 1 is thus set into the measurement state.

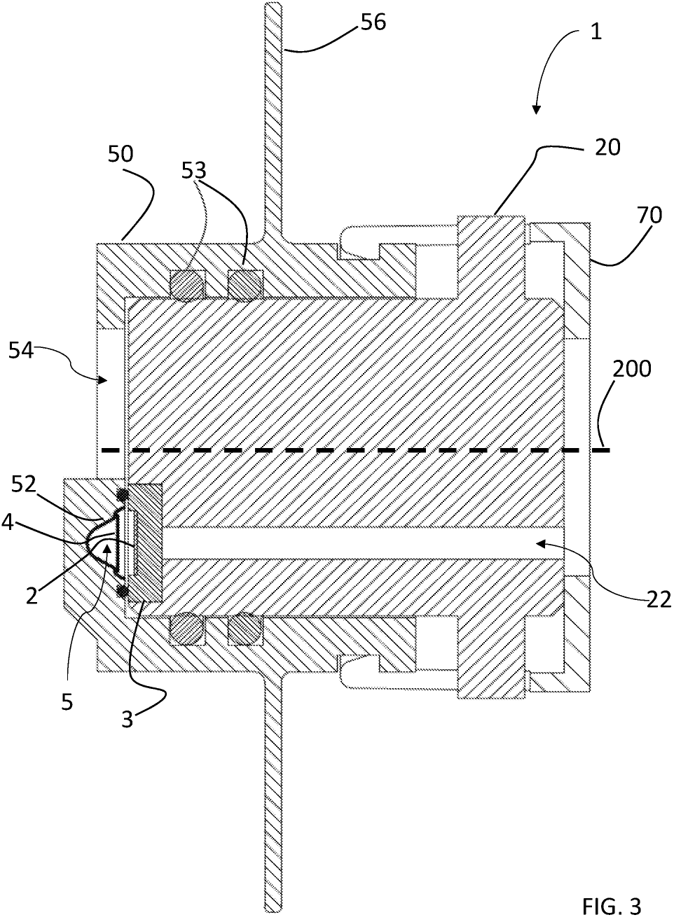

FIG. 3 shows a sectional view of a further embodiment of the sensor unit 1. The sensor unit 1 is shown in the preparation state. The sensor unit 1 comprises a sensor part 20, to which the sensor element 2 is attached by support 3. The sensor unit 1 further comprises a reservoir part 50 in which the reservoir 5 is formed. The reservoir 5 is delimited on one side by the membrane 4 and likewise attached to the reservoir part 50. The reservoir 5 is delimited on other sides by a metallized foil 52. The foil 52 acts as a diffusion barrier. A channel 22 for a light guide is formed in the sensor part 20. A light guide can be passed to the support 3 via the channel 22 in order to guide light to the sensor element 2 through the light guide and via the support 3 and/or to guide light away from the sensor element 2. This serves to detect the optical behavior of the sensor substance in the sensor element 2. The reservoir part 50 furthermore has an opening 54, through which contact between a sample and the sensor element 2 is possible in the measurement state. In the preparation state shown, there is diffusive contact between the sensor element 2 and the reservoir 5 via the membrane 4, so that the auxiliary medium (not shown here) in the reservoir 5 or components thereof can reach the sensor element 2 by diffusion through the membrane 4.

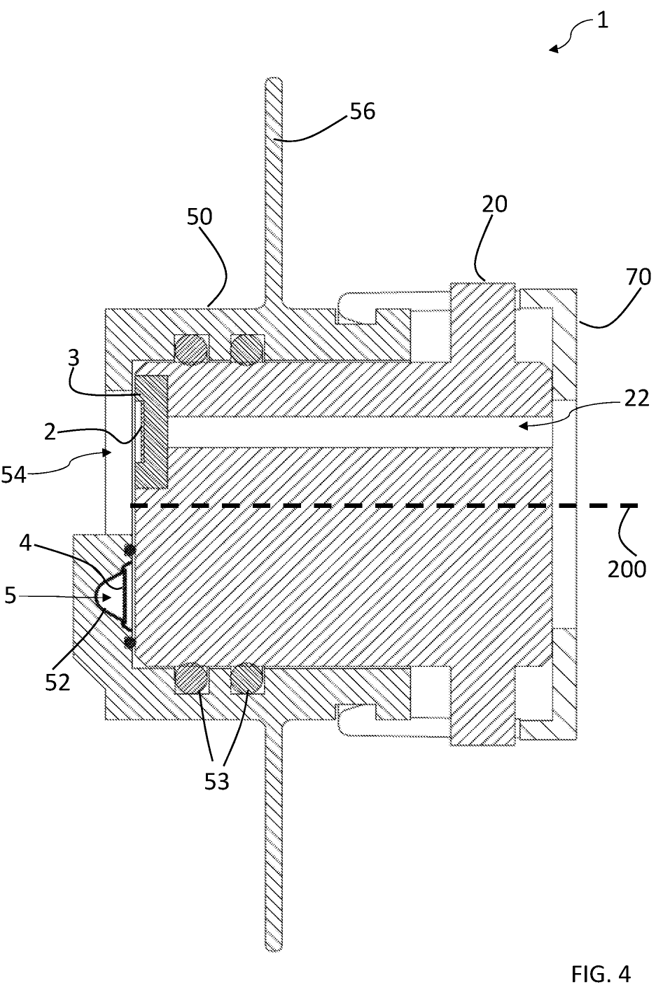

Sensor part 20 and reservoir part 50 are rotatable relative to one another about an axis 200. By such a rotation, sensor unit 1 can be set into the measurement state shown in FIG. 4. Sensor part 20 and reservoir part 50 are sealed against one another by O-rings 53. Flange 56 on reservoir part 50 serves to fasten sensor unit 1 to a sample vessel. Depending on the configuration of the sample vessel and sensor unit 1, this fastening can be carried out differently. If, for example, the sample vessel is a bag made of plastic and the flange 56 is also made of plastic, then the bag and flange may be welded or else glued. If the sample vessel has a stronger wall, the flange may be connected to the wall, for example, by a screw connection or via a bayonet lock. In the embodiment shown, a retaining bracket 70 ensures the cohesion of reservoir part 50 and sensor part 20.

FIG. 4 shows the sensor unit 1 from FIG. 3 in the measurement state. Here, a sample can now reach the sensor element 2 through opening 54. In contrast, there no longer is diffusive contact between the reservoir 5 and the sensor element 2.

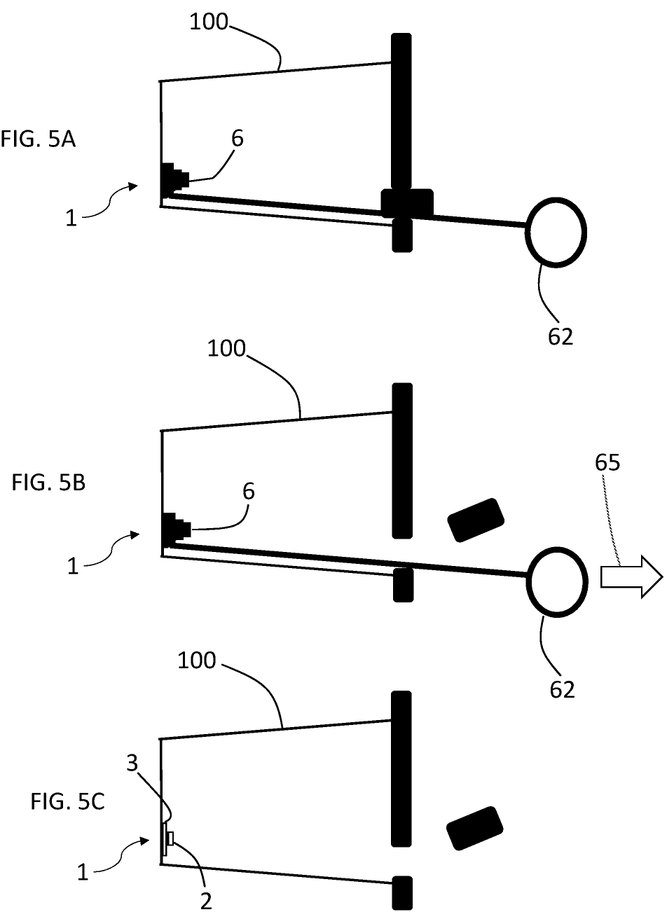

FIGS. 5A-C show a sequence of three stages before a measurement with a sensor unit 1 according to the present disclosure. The sensor unit 1, which corresponds to the embodiment shown in FIGS. 1 and 2, is inserted into a sample vessel 100, for instance adhesively bonded to the base of the sample vessel 100. At FIG. 5A, cap 6 covers the sensor element and the reservoir (not shown here, see FIGS. 1 and 2) and the handle 62 is angled and passed out of the sample vessel 100. In this state, the sample vessel 100 together with the sensor unit 1 can be irradiated for sterilization, and the sensor element is protected by the cap 6. The sample vessel 100 together with the sensor unit 1 can also be stored. In FIG. 5B, the cap 6 together with the reservoir and membrane (see FIGS. 1 and 2) is pulled off the sensor unit 1 by a force 65 on the handle 62, thus reaching the third stage, as shown in FIG. 5C. In FIG. 5C, the sensor element 2, fastened to the support 3, is accessible from the interior of the sample vessel 100.

The sample vessel 100 can then be filled with a sample. Subsequently, the measurement can be performed using the sensor element 2.

It is believed that the present disclosure and many of its attendant advantages will be understood by the foregoing description, and it will be apparent that various changes may be made in the form, construction, number and arrangement of the components without departing from the disclosed subject matter. The form described is merely explanatory, and it is the intention of the following claims to encompass and include such changes. Accordingly, the scope of the invention should be limited only by the claims appended hereto.

What is claimed is:

1. A sensor unit comprising:
a sensor element comprising an optical behavior, wherein the optical behavior depends on at least one analyte of a sample;
a reservoir with an auxiliary medium; and
a membrane wherein, in a preparation state of the sensor unit, the membrane enables a diffusive contact between the auxiliary medium and the sensor element, wherein the sensor unit is placed in a measurement state by removal from one another of the sensor element on the one hand and of the membrane and of the reservoir on the other hand.

2. The sensor unit according to claim 1, wherein the reservoir and the membrane are detachably connected to the sensor unit.

3. The sensor unit according to claim 2, further comprising a cap, wherein the cap is configured to cover the reservoir and the sensor element.

4. The sensor unit according to claim 3, wherein the sensor element is arranged on a support, the cap is detachably connected to the support, and the membrane is fastened in the cap.

5. The sensor unit according to claim 1, wherein the sensor unit further comprises: a sensor part, wherein the sensor element is attached to the sensor part; a reservoir part, wherein the reservoir is formed and the membrane is attached; and wherein the reservoir part and the sensor part are rotatable or displaceable with respect to one another.

6. The sensor unit according to claim 5, wherein the sensor part comprises a channel for guiding an optical waveguide.

7. The sensor unit according to claim 5, wherein the reservoir part comprises an opening through which the sensor element in the measurement state of the sensor unit is accessible from an environment of the sensor unit.

8. The sensor unit according to claim 1, wherein the auxiliary medium in the reservoir is configured as a storage medium for storing the sensor element in a wetted state in the sensor unit.

9. The sensor unit according to claim 8, wherein the storage medium comprises water or a lye.

10. The sensor unit according to claim 8, wherein the storage medium comprises an antimicrobial preservative.

11. The sensor unit according to claim 8, wherein the storage medium sets a defined state for calibrating the sensor element.

12. A sample vessel comprising:
a sensor unit positioned in the sample vessel, wherein the sensor unit comprises:
a sensor element comprising an optical behavior, wherein the optical behavior depends on at least one analyte of a sample;
a reservoir with an auxiliary medium; and
a membrane, wherein, in a preparation state of the sensor unit, the membrane enables a diffusive contact between the auxiliary medium and the sensor element, wherein the sensor unit is placed in a measurement state by removal from one another of the sensor element on the one hand and of the membrane and of the reservoir on the other hand.

13. The sample vessel of claim 12, wherein the reservoir and the membrane are detachably connected to the sensor unit.

14. The sample vessel of claim 13, further comprising a cap, wherein the cap is configured to cover the reservoir and the sensor element.

15. The sample vessel of claim 14, wherein the sensor element is arranged on a support, the cap is detachably connected to the support, and the membrane is fastened in the cap.

16. The sample vessel of claim 12, wherein the sensor unit further comprises: a sensor part, wherein the sensor element is attached to the sensor part; a reservoir part, wherein the reservoir is formed and the membrane is attached; and wherein the reservoir part and the sensor part are rotatable or displaceable with respect to one another.

17. The sample vessel of claim 16, wherein the sensor part comprises a channel for guiding an optical waveguide.

18. The sample vessel of claim 16, wherein the reservoir part comprises an opening through which the sensor element in the measurement state of the sensor unit is accessible from an environment of the sensor unit.

19. The sample vessel of claim 12, wherein the auxiliary medium in the reservoir is configured as a storage medium for storing the sensor element in a wetted state in the sensor unit.

20. The sample vessel of claim 19, wherein the storage medium comprises water or a lye.

21. The sample vessel of claim 19, wherein the storage medium comprises an antimicrobial preservative.

22. The sample vessel of claim 19, wherein the storage medium sets a defined state for calibrating the sensor element.

23. The sample vessel of claim 12, wherein the sample vessel is sterilized.

24. A method of measuring an analyte in a sample, the method comprising:
providing a sample vessel with a sensor unit, wherein the sensor unit comprises:
a sensor element comprising an optical behavior, wherein the optical behavior depends on at least one analyte of a sample;
a reservoir with an auxiliary medium; and
a membrane, wherein, in a preparation state of the sensor unit, the membrane enables a diffusive contact between the auxiliary medium and the sensor element, wherein the sensor unit is placed in a measurement state by removal from one another of the sensor element on the one hand and of the membrane and of the reservoir on the other hand;
sterilizing the sample vessel;
removing the sensor element, on the one hand, and the reservoir and the membrane, on the other hand, from one another in order to make the sensor element accessible from the sample vessel;
filling the sample vessel with the sample; and
performing a measurement of the analyte using the sensor element of the sensor unit.

25. A method for manufacturing a sensor unit, the method comprising:
creating a cavity in a precut foil;
attaching a sensor element to a transparent support, wherein the sensor element comprises an analyte dependent optical behavior;
filling the cavity with an auxiliary medium;
laying a membrane on the filled cavity and fastening the membrane to the foil, wherein the membrane is diffusive for the auxiliary medium;
placing the support with the sensor element on the membrane, wherein the sensor element is configured toward the membrane in order to come into contact with the auxiliary medium diffused through the membrane; and
fixing the support on the foil such that the foil together with the membrane and the cavity with the auxiliary medium can be removed from the support with the sensor element.
